(19) United States
(12) Patent Application Publication
(10) Pub. No.: US 2006/0118580 A1
(43) Pub. Date: Jun. 8, 2006

(54) Dispensing apparatus and a dispensing nozzle for use therewith

(76) Inventor: Alan Spencer, Middlesborough (GB)

Correspondence Address: NIKOLAI & MERSEREAU, P.A., 900 SECOND AVENUE SOUTH, SUITE 820, MINNEAPOLIS, MN, 55402, US

(21) Appl. No.: 11/295,101

(22) Filed: Dec. 6, 2005

(30) Foreign Application Priority Data
Jun. 6, 2003 (GB) GB20030012974
Feb. 9, 2004 (WO) PCT/GB04/00108

(51) Int. Cl. B65D 88/54; G01F 11/06; G01F 11/30; G01F 11/36; G01F 11/42

(52) U.S. Cl. 222/327

(57) ABSTRACT

A dispensing nozzle is provided which is attachable to dispensing apparatus. The nozzle includes attachment means for attaching the nozzle to the apparatus, inlet means through which a fluid can flow from the dispensing apparatus into the dispensing nozzle, and outlet means through which the fluid can be dispensed from said dispensing nozzle. The outlet means includes two or more outlets to facilitate simultaneous multiple dispensing of fluid, such as grout adhesive, to a surface, such as a tile surface.

This patent application relates to dispensing apparatus, and to a dispensing nozzle for use with dispensing apparatus.

Although the following description refers almost exclusively to dispensing apparatus for dispensing a fluid in the form of grout onto a tile surface, it will be appreciated by persons skilled in the art that the present invention can be used for dispensing any fluid onto a required surface, such as dispensing glue onto an article and/or the like.

Conventionally, in order to adhere tiles to a wall surface, grout is applied to the rear surface of the tile. This can be done by hand but this typically results in uneven amounts of grout being applied to the rear of the tile, thereby causing levelling problems when the tile is attached to the wall surface. In order to overcome this problem, the grout can be dispensed using dispensing apparatus, such as a dispensing gun. Such guns typically comprise a reservoir for the containment of the grout, an outlet nozzle located at a first end of the reservoir for dispensing grout therefrom and a plunger located at an opposite end of the reservoir for moving the grout through the reservoir for expulsion through the outlet nozzle. Actuation means, typically in the form of a gun like trigger mechanism, can be provided in communication with the plunger to enable a user to easily dispense grout from the reservoir in a controlled manner. However, a problem with conventional dispensing apparatus, such as the dispensing gun, is that only small quantities of grout can be dispensed at any one time. As such, a user is typically required to undertake a plurality of dispensing actions, such as by applying individual lines of grout onto the tile at spaced distances. This is time consuming and frustrating for the user and also the user cannot guarantee that the distribution of the grout on the tile is sufficiently even to allow adequate levelling of the tile on the wall.

It is therefore an object of the present invention to provide dispensing apparatus which allows fluid to be dispensed therefrom both quickly and easily in a controlled and consistent manner and, more specifically, to provide a dispensing nozzle for use with such dispensing apparatus.

According to a first aspect of the present invention there is provided a dispensing nozzle for use with dispensing apparatus, said dispensing nozzle including attachment means for attaching said dispensing nozzle to said dispensing apparatus, inlet means through which a substance can flow from said dispensing apparatus into said dispensing nozzle and outlet means through which the substance can be dispensed from said dispensing nozzle, and wherein said outlet means includes two or more outlets.

The provision of multiple outlets in the nozzle allows a larger volume of said substance to be dispensed at any one time, thereby reducing the time and effort input in dispensing a substance by the user. The number of outlets is typically dependent on the amount of substance to be dispensed or the number of lines of substance to be dispensed.

The substance can include one or more components and can include any flowable material, such as a fluid, powder, granular and/or particulate matter.

Preferably the substance flows through the two or more outlets substantially simultaneously on activation of the dispensing apparatus. This allows consistency of the quantities of substance dispensed therefrom.

Preferably each outlet of the nozzle is in communication with the other outlet or outlets.

Preferably the two or more outlets of said dispensing nozzle are provided a pre-determined space apart. In one embodiment the distance between the outlets is dependent on the size of the article into or onto which the substance is to be dispensed. The distance between adjacent outlets can differ on any particular nozzle but preferably the outlets are substantially equal distances apart

Preferably the dispensing nozzle includes a body portion and the two or more outlets are provided on or in communication with the body portion.

The outlets can be provided at substantially the same angle relative to the body portion of the nozzle and/or other outlets for dispensing said substance therefrom in substantially the same direction. Alternatively, the outlets can be provided at different angles relative to each other and/or relative to the body portion of the nozzle, thereby allowing said substance to be dispensed therefrom at different angles and/or directions.

In one embodiment the outlets are substantially aligned in a linear arrangement and are preferably planar, thereby allowing said substance to be dispensed therefrom in substantially the same direction and from the same height relative to an article in or on which the substance to be dispensed. As such, the substance is typically dispensed at the same speed and/or pressure from all the nozzles, thereby allowing increased control and accuracy.

The length of the outlet portions can vary or can be the substantially the same.

Preferably the attachment means can include any or any combination of screw threads, clips, friction fit, adhesive, welding, screws, nuts and bolts, ties and/or the like. Attachment between the dispensing nozzle and dispensing apparatus can be provided directly or indirectly via one or more intermediary components.

In a preferred embodiment the dispensing nozzle includes five outlets.

In alternative embodiments the outlets can be arranged in a non-linear manner such as for example, they be arranged in a substantially circular configuration (i.e. the outlets of the apertures are arranged around the circumference of a circle) or a cruxiform configuration, such that the substance can be dispensed from the dispensing apparatus in small packets or blobs as an alternative manner to lines. Such configurations enable the user to dispense a set amount of said substance from the dispensing apparatus at a number of different locations simultaneously.

Preferably each outlet includes a protrusion portion or arm joined to the body portion at one end and an outlet aperture provided at the other free end. A channel is provided through the protrusion portion which communicates with the interior of the body portion at a first end and the outlet aperture at a second end.

In one embodiment the protrusion portion or arm of each outlet is integrally formed with the body portion of the dispensing nozzle, such that the direction(s) and/or angle(s) of flow of the substance from the outlets is/are fixed.

In an alternative embodiment the position of at least one of the protrusion portions or arms of each outlet can be adjusted, such as by rotatably, pivotally, or otherwise adjustably mounting the same to the body portion of the dispensing nozzle, such that the direction and/or angle of flow of the substance from each outlet can be individually adjusted.

The body portion typically defines a cavity in which the substance is located prior to being dispensed from said outlets. The substance can be stored in the body portion cavity in addition to the reservoir of the dispensing apparatus when the nozzle/apparatus is not in use.

Preferably the inlet means includes at least on channel which communicated with the two or more outlets.

Further preferably two or more sub-channels are provided in communication with the inlet channel. The sub-channels typically diverge outwardly from the inlet channel and typically on opposite sides thereof.

One or more outlet channels can be provided in communication with the sub-channels, the outlet channels leading to the outlet apertures at an end thereof.

In one embodiment closure means are provided with one or more of said outlets to close the outlet apertures of said outlets when use thereof is not required. Thus, for example, if said substance is required to be dispensed in a smaller area than the area provided by all the outlets, i.e. the width of the location on which said substance is to be dispensed is less than the width of the furthest apart outlets, one or more of the outlets can be closed via said closure means so that the substance is only dispensed in the required area. The closure means also prevent deterioration or drying of the substance contained in the nozzle when the nozzle is not in use.

Preferably the closure means include projection means which project into the outlets when the outlet apertures are closed by the closure means. The projection means displace any substance remaining in the outlet back towards the body portion of the nozzle, preventing the substance from remaining in the outlet and blocking the outlet should the substance become solid.

In a further embodiment, closure means are provided in the form of valve means on one or more of said outlets, such that the speed and/or degree of flow of said substance from an outlet can be individually adjusted according to the requirements of the user.

According to a second aspect of the present invention there is provided dispensing apparatus, said dispensing apparatus including a reservoir for the containment of a substance to be dispensed, a dispensing nozzle having inlet means through which the substance from the reservoir can flow into the nozzle, outlet means through which the substance can be dispensed from said nozzle, and actuation means for actuating the flow of said substance from said reservoir and through the outlet means of said dispensing nozzle, and wherein said outlet means includes two or more outlets.

In one embodiment the dispensing nozzle is provided with attachment means for attaching said nozzle to said reservoir or to one or more intermediate components provided between said reservoir and said nozzle.

In an alternative embodiment the dispensing nozzle is integrally formed with said reservoir or with one or more intermediate components provided between said reservoir and said nozzle.

The advantage of the present invention is that a larger volume of substance can be dispensed at pre-determined spaced apart locations in a controlled and consistent manner, thereby reducing the time taken to dispense a substance onto a required surface or article.

Embodiments of the present invention will now be described with reference to the accompanying figures wherein:

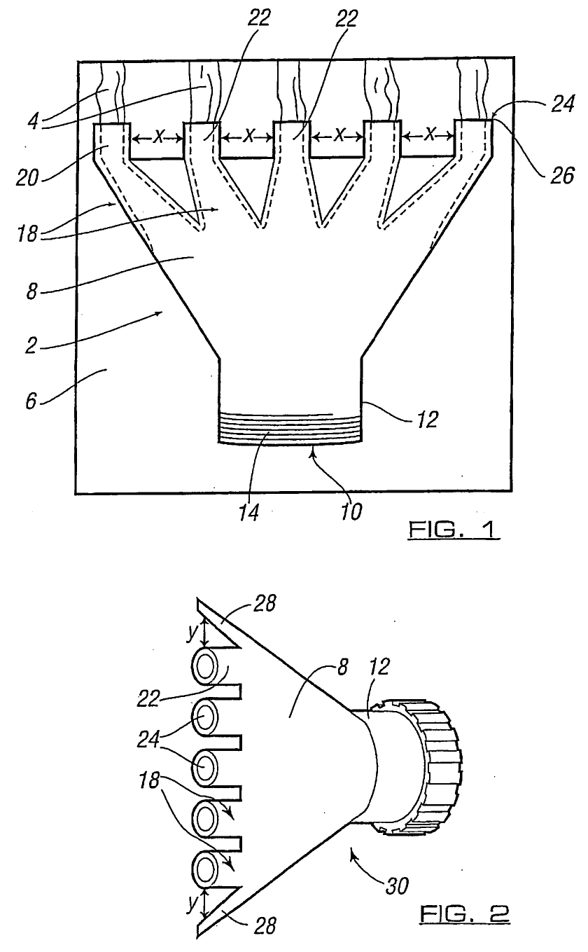

FIG. 1 is an example of a dispensing nozzle according to an embodiment of the present invention in use according to one embodiment;

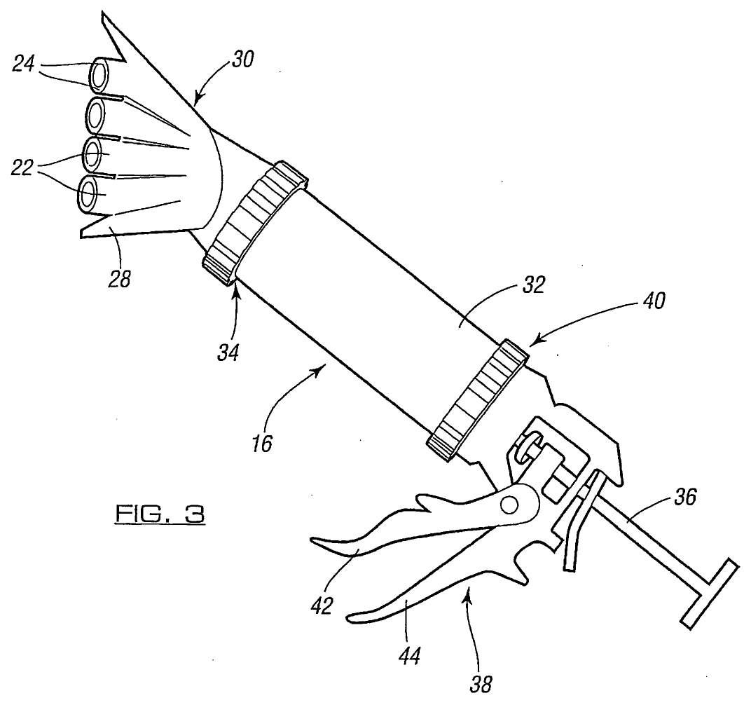

FIG. 2 is an example of dispensing nozzle according to a further embodiment of the present invention;

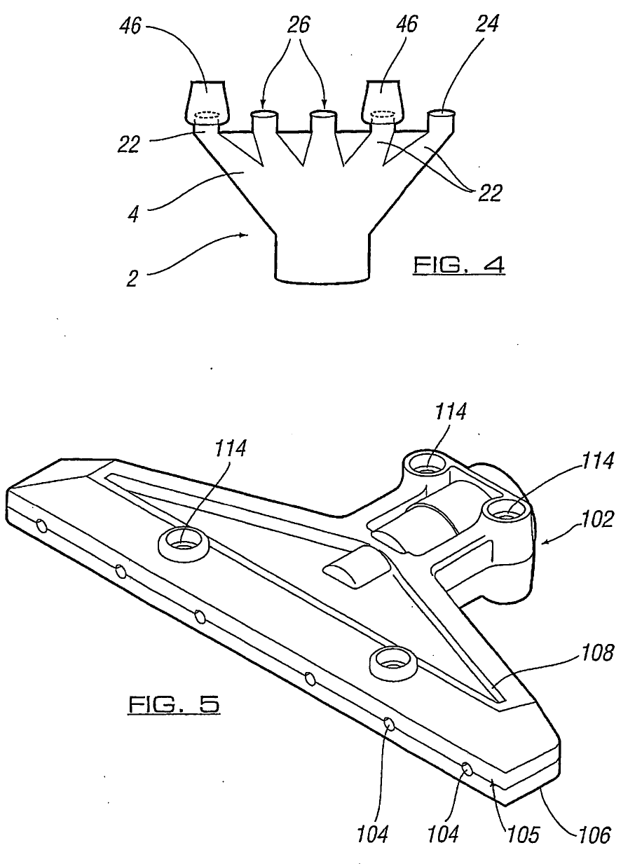

FIG. 3 illustrates the dispensing nozzle in FIG. 2 in use with dispensing apparatus in one example;

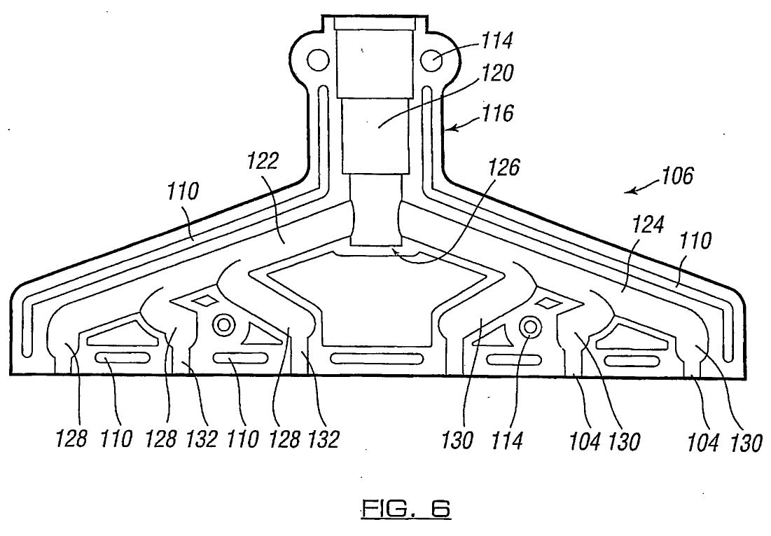

FIG. 4 is an example of closure means for use with the dispensing nozzle shown in FIG. 1;

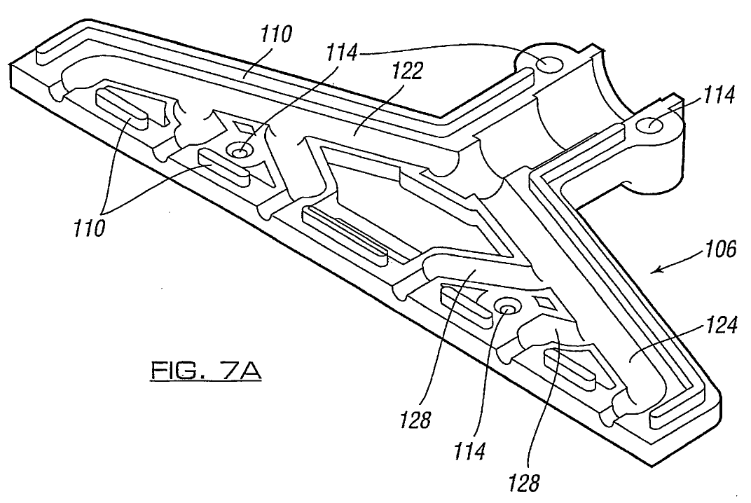

FIG. 5 illustrates an example of a dispensing nozzle according to a further embodiment of the present invention;

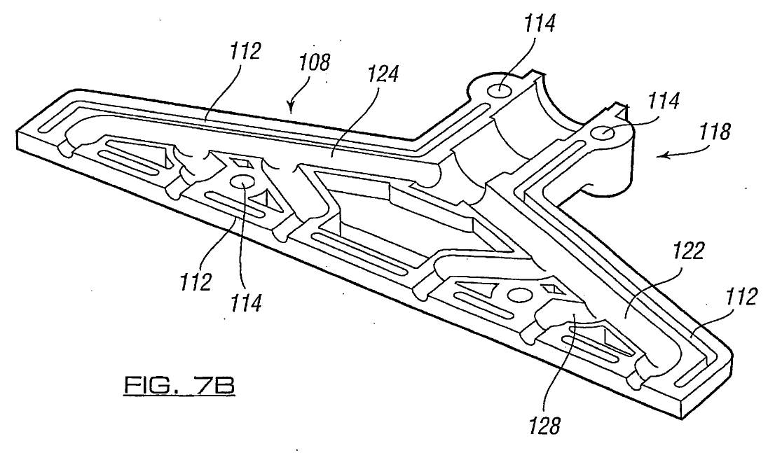

FIG. 6 is a plan view of part of the nozzle shown in FIG. 5;

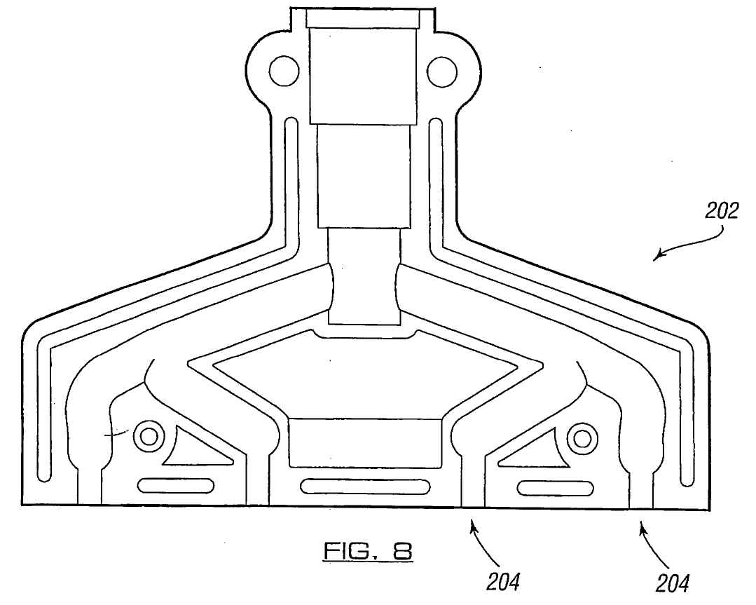

FIG. 7a is a perspective view of the part of the nozzle shown in FIG. 6;

FIG. 7b is a perspective view of the connecting part of the nozzle shown in FIG. 7a;

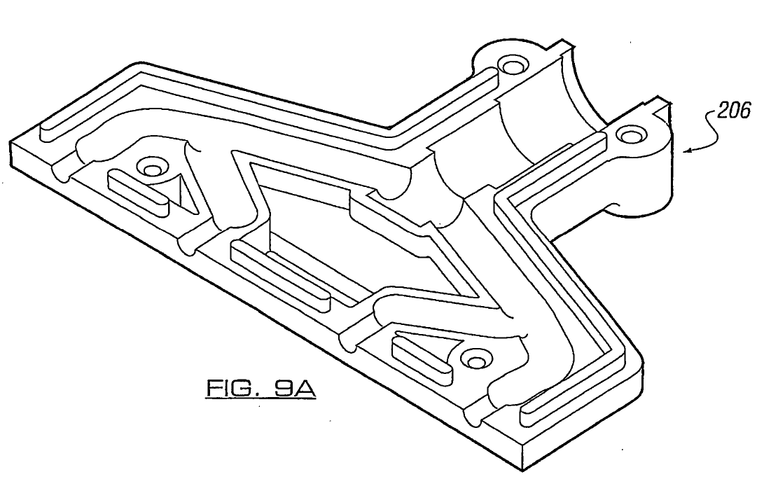

FIG. 8 is a plan view of part of a nozzle according a yet further embodiment of the present invention; and

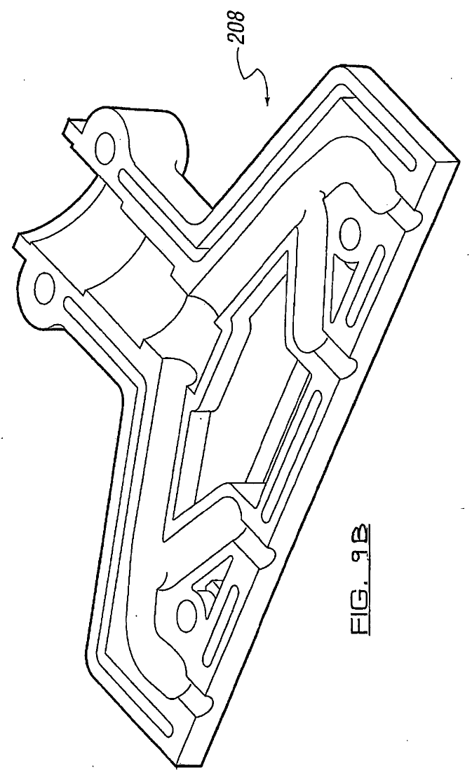

FIGS. 9a and 9b illustrate view of the connecting parts of the nozzle shown in FIG. 8.

Referring to FIG. 1, there is illustrated a multiple outlet dispensing nozzle 2 according to the present invention for dispensing a fluid in the form of grout adhesive 4 onto a tile 6. The nozzle 2 includes a body portion 8 which defines an internal cavity for the storage and/or passage of fluid therein or therethrough. An inlet aperture 10 is provided in a neck portion 12 which communicates with body portion 8.

Attachment means in the form of a screw thread 14 is provided on an external surface of neck portion 12 thereby allowing the attachment of nozzle 2 to dispensing apparatus 16 via complementary screw threads provided on the dispensing apparatus.

Five outlets 18 are integrally formed with the body portion of the nozzle at a location substantially opposite to inlet aperture 10, thus providing a finger type of formation. Each outlet 18 includes a protruding member 20 with a channel 22 provided therethrough and an outlet aperture 24 provided at a free end 26 thereof, typically at a point furthest from body portion 8. The channels 22 of each outlet 18 are in communication with each other via said body portion 8.

The free ends 26 of the outlets 18 are substantially planar and aligned, with a distance x provided between adjacent outlets, the distance x being substantially the same for each outlet. As such, the lines of grout 4 dispensed from said outlets 18 onto tile 6 are also provided at substantially equal distances x apart. This provides consistency between the levels of grout provided on a plurality of tiles, thereby allowing easy levelling of the tiles on a wall surface. In addition, since the body portion is substantially symmetrical in shape, application of pressure to the fluid therein produces substantially equal fluid pressure at each of the outlets, thereby allowing similar amounts of fluid to flow through the outlet. It will be appreciated that different shaped body portions could be provided to allow an uneven pressure distribution therein, thereby providing a pre-determined but uneven distribution of fluid therefrom.

In a further embodiment of the present invention, guide means in the form of arm members or runners 28 can be provided at either end of the outlet formations of dispensing nozzle 30, as shown in FIG. 2. These runners allow a user to align the nozzle up with the edges of tile 6 and to guide the nozzle along the tile in use, thereby allowing controlled and accurate dispensing of the grout on the tile. It will be appreciated that the distance y from each outermost runner to the adjacent outlet 22 is dependent on the size of the tile which the grout is being located on. One or more guide means can also be provided between adjacent outlets if required. Components of nozzle 30 which are the same as nozzle 2 in FIG. 1 are illustrated using the same reference numerals.

Referring to FIG. 3, there is illustrated dispensing apparatus 16 of a type suitable for use with dispensing nozzle 30 or nozzle 2. The dispensing apparatus 16 is in the form of a dispensing gun, including a reservoir 32 for the storage of grout therein. The reservoir 32 has an outlet portion at one end 34 to allow fluid to flow from said reservoir into said dispensing nozzle 30. The outlet portion is provided with a screw thread which is complementary to the screw thread 14 provided on the nozzle, thereby allowing the nozzle to be detachably attached to the dispensing apparatus.

Actuation means in the form of a plunger 36 and trigger mechanism 38 are provided at the other end 40 of dispensing apparatus 16. In use, a user moves the plunger 36 towards said reservoir 32 by squeezing or moving together the two members 42, 44 of the trigger mechanism 38. Movement of plunger 36 towards end 3.4 of reservoir 32, forces grout from said reservoir, through said outlet portion and into nozzle 30 for dispensing from outlet apertures 24.

Closure means in the form of caps 46 can be provided for attachment over said free ends 26 of said outlets 18 to close one or more of the outlet apertures 24 when use of the same is not required. Attachment of the caps 46 in this example is by friction fit but any form of engagement of attachment means can be used. In addition, the caps 46 can be joined together to prevent them from being separated and lost.

Thus, one or more outlet apertures can be closed during use of the dispensing nozzle, thereby reducing the number of outlet apertures available for dispensing, such as for example, if the width of the tile for which grout is to be applied is less than the total width of the furthest apart outlets 18. As such, the furthest apart outlets are capped. Alternatively, for example, if only two lines of grout need to be applied to a tile, the required spacing between two outlets can be provided by capping or closing intermediate and/or end outlets. The caps 30 can also be used to close all the outlet apertures when the nozzle is not in use, thereby preventing deterioration or drying of any fluid in the body portion 4 and/or outlets 18. The engagement of the closure means on a particular outlet is such that the pressure of dispensing fluid from the other outlets does not result in accidental detachment of the closure means therefrom. The attachment means of the closure means can be any or any combination of friction fit, clips, screw threads and/or the like.

The invention can have any number of outlets equal to or greater than two outlets to allow a substance, such as grout, to be dispensed simultaneously and evenly onto the rear surface of the tile, thereby reducing the time and effort associated with this particular application. It will be appreciated by persons skilled in the art that the dispensing nozzle of the present invention can be adapted for use with any required application, wherein multiple lines, columns, rows and/or the like of a particular fluid can be dispensed. Any number of rows of grout can be dispensed depending on the number of dispensing nozzles provided and is not limited to five as in the above example.

The nozzle can be provided in any required shape and/or size and can have any number of outlet apertures provided therewith. The nozzle can be formed from any of any combination of plastic, metal, wood or any other suitable material.

The fluid can be any flowable substance, but is typically a viscous fluid, and can include one or more constituents as required.

Referring to FIGS. 5-7b, there is illustrated a further embodiment of the present invention including a dispensing nozzle 102 having six outlet apertures 104 provided at a first planar end 105. Nozzle 102 is formed from two parts 106, 108 which are detachably connected together by connection means.

The connection means can include any or any combination of screws, nuts and bolts, welding, friction fit, protrusions/recesses, clips, adhesive and/or the like. In this example part 106 is provided with protrusion portions 110 which engage with complementary recess portions 112 at corresponding positions on part 108. In addition, screw holes 114 are provided on parts 106, 108 to allow further securement of the parts together using screws (not shown). This has the advantage that a user can easily separate the parts to clean any fluid therein which has become dried and/or has blocked any of the dispensing channels therein and/or outlet apertures. In addition, provision of the protrusions and recess portions prevents shrinking and sinking of plastic material in the mould during manufacture (in the example when the dispensing nozzle is formed from plastics material).

The first and second parts forming the dispensing nozzle are typically sealingly connected together by whatever connection means are used.

Each part 106, 108 is typically provided with a neck portion 116, 118 respectively and this neck portion is attached to the outlet end of a dispensing gun, dispensing tube or similar. In this example, the attachment is a push fit arrangement but other attachment means can be provided if required.

An inlet channel 120 is provided in each neck portion 116, 118 and two sub-channels 122, 124 diverge from an end 126 of the inlet channel. From each of these two sub-channels 122, 124, three outlet channels 128, 130 are provided respectively. The outlet channels 128, 130 end in the outlet apertures 104.

The channel arrangements are typically required to be symmetrical to allow substantially even dispensing of fluid from the outlet apertures 104. The distance from the centre of inlet channel 120 at end 126 to each outlet aperture 104 is substantially the same for each outlet aperture. This allows the dispensing nozzle to have an even flow of fluid therefrom at the same time. In order to achieve this, the length of the outlet channels and the length of the outlet aperture portion differs accordingly. For example, the outlets furthest from the centre of the nozzle have only short outlet channels 128, 130 and short outlet aperture portions 132, whereas the inner most outlets (i.e. nearest to the centre of the nozzle) have the longest outlet channels and the longest outlet aperture portion 132. It will appreciated however that the ratio of lengths of outlet channels and/or outlet aperture portions from a central position in the nozzle can be varied as required to allow different flow rates of the fluid to be produced from different outlet apertures.

The outlet aperture portions 132 or outlet apertures in this example have a smaller cross sectional area than the outlet channels 128, 130, thereby reducing the pressure required to be applied by a user on actuation means connected to the dispensing apparatus. This also allows narrower beads of fluid to be provided to increase the accuracy of the apparatus. The cross sectional area of the aperture portions could be altered to provide different flow rates of fluid if required. Preferably the outlet apertures are one third the cross sectional area of the outlet channels 128, 130.

The channel arrangement in the dispensing nozzle in this embodiment also has the advantage that it is relatively easy for a user to push air from the channels upon first use of the nozzle with a fluid.

A further example of a dispensing nozzle 202 is shown in FIGS. 8-9b. Nozzle 202 has four outlet apertures 204 located in a substantially linear and planar arrangement compared to the six outlet apertures shown in FIGS. 6-7b. It will therefore be appreciated that any number of apertures can be provided with the nozzle as required. Nozzle 202 is formed from a first part 206 and a second part 208 joined together in a similar manner to nozzle 102.

Although the outlet apertures are defined in a substantially continuous planar surface in the abovementioned examples, it will be appreciated that the outlet apertures could be provided at the end of protrusion portions as in the examples of FIGS. 1-4.

The nozzle can be formed from any suitable plastic, metal or wood material. For example, the nozzle can be formed from a glass filled polypropylene material, thereby providing the nozzle with strength and rigidity.

It will be appreciated that any of the above features can be provide alone or in combination with any other feature described herein and fall within the scope of the invention.

Thus, the present invention has the significant advantage that due to the ratios of cross sectional areas and/or lengths of the outlet apertures compared to the outlet channels and the inlet channel, any number of outlet apertures can be provided whilst providing even and substantially simultaneous dispensing of fluid from the nozzle. In addition, any viscosity of fluid can be used with any particular dispensing nozzle.

I claim:

1. A dispensing nozzle for use with dispensing apparatus, said dispensing nozzle including attachment means for attaching said dispensing nozzle to said dispensing apparatus, inlet means through which at least one substance can flow from said dispensing apparatus into said dispensing nozzle and two or more outlets, each outlet including an outlet aperture through which the substance can be dispensed from said dispensing nozzle, characterised in that the distance from a central point of said inlet means to each of said outlet apertures is substantially the same.

2. A dispensing nozzle according to claim 1 characterised in that said substance flows through said two or more outlet apertures substantially simultaneously and at substantially the same rate.

3. A dispensing nozzle according to claim 1 characterised in that said substance flows through said two or more outlet apertures on activation of said dispensing apparatus.

4. A dispensing nozzle according to claim 1 characterised in that at least one of said outlets is in communication with at least one other of said outlets.

5. A dispensing nozzle according to claim 1 characterised in that said two or more outlet apertures are provided at pre-determined and substantially equal spaced distances apart.

6. A dispensing nozzle according to claim 1 characterised in that the outlet apertures are provided at different distances apart.

7. A dispensing nozzle according to claim 1 characterised in that said dispensing nozzle includes a body portion, and said two or more outlets are provided on said body portion.

8. A dispensing nozzle according to claim 7 characterised in that said a body portion includes a cavity for storing a substance to be dispensed therein.

9. A dispensing nozzle according to claim 7 characterised in that each of said outlets include a protrusion portion connected to said body portion at a first end, an outlet aperture provided at a free end, distal to said body portion and a channel provided between the body portion and the outlet aperture.

10. A dispensing nozzle according to claim 9 characterised in that said protrusion portion is adjustably mounted on said body portion.

11. A dispensing nozzle according to claim 7 characterised in that the outlets are provided at substantially the same angle relative to said body portion.

12. A dispensing nozzle according to claim 7 characterised in that the outlets are provided at substantially different angles relative to said body portion.

13. A dispensing nozzle according to claim 1 characterised in that outlet are provided at substantially the same angle relative to each other.

14. A dispensing nozzle according to claim 1 characterised in that outlets are provided at different angles relative to each other.

15. A dispensing nozzle according to claim 1 characterised in that the free ends of the outlets are aligned in a substantially linear arrangement.

16. A dispensing nozzle according to claim 1 characterised in that the free ends of the outlets are arranged in a substantially circular configuration.

17. A dispensing nozzle according to claim 1 characterised in that the free ends of the outlets are arranged in a cruxiform arrangement.

18. A dispensing nozzle according to claim 1 characterised in that the outlets are provided with closure means.

19. A dispensing nozzle according to claim 18 characterised in that said closure means include projection means which project into the outlets when said closure means are associated with said outlets in a closed position.

20. A dispensing nozzle according to claim 18 characterised in that said closure means are provided in the form of valve means.

21. A dispensing nozzle according to claim 1 characterised in that the attachment means includes any or any combination of screw threads, clips, friction fit, adhesive, welding, screws, nuts and bolts or ties.

22. A dispensing nozzle according to claim 7 characterised in that the outlet means are integrally formed with the body portion.

23. A dispensing nozzle according to claim 7 characterised in that the outlet means are detachably attached to said body portion either directly or indirectly via one or more intermediary components.

24. A dispensing nozzle according to claim 1 characterised in that guide means are provided thereon.

25. A dispensing nozzle according to claim 1 characterised in that the nozzle includes at least first and second parts which are connected together in use via connection means.

26. A dispensing nozzle according to claim 25 characterised in that the connection means includes any or any combination of one or more screws, clips, nuts and bolts, protrusions/recesses, adhesive, welding or friction fit.

27. A dispensing nozzle according to claim 1 characterised in that the inlet means includes at least one channel which branches into two or more sub-channels, the sub-channels communicating with two or more outlet apertures.

28. A dispensing nozzle according to claim 27 characterised in that an outlet channel is provided between the sub-channel and an outlet aperture.

29. A dispensing nozzle according to claim 28 characterised in that the distance between each outlet aperture and a central point of the inlet means is substantially the same.

30. A dispensing nozzle according to claim 28 characterised in that the outlet apertures have a smaller cross sectional area than the outlet channels.

31. A dispensing nozzle according to claim 30 characterised in that the cross sectional area of each outlet aperture is approximately one third of the cross sectional area of the outlet channel with which it communicates.

32. A dispensing apparatus, said dispensing apparatus including a reservoir for the containment of a substance to be dispensed, a dispensing nozzle having inlet means through which said substance from the reservoir can flow into the nozzle, outlet means through which the substance can be dispensed from said nozzle, and actuation means for actuating the flow of said substance from said reservoir and through said outlet means of said dispensing nozzle, and characterised in that said outlet means includes two or more outlets.
